(19) United States
(12) Patent Application Publication
(10) Pub. No.: US 2016/0126558 A1
(43) Pub. Date: May 5, 2016

(54) THREE-DIMENSIONAL (3D) ELECTRODE ARCHITECTURE FOR A MICROBATTERY

(71) Applicant: The Board of Trustees of the University of Illinois, Urbana, IL (US)

(72) Inventors: Jennifer Lewis, Cambridge, MA (US); Shen Dillon, Champaign, IL (US); Ke Sun, Urbana, IL (US); Bok Yeop Ahn, Cambridge, MA (US); Teng-Sing Wei, Somerville, MA (US)

(21) Appl. No.: 14/890,072

(22) PCT Filed: May 1, 2014
(86) PCT No.: PCT/US2014/036322

§ 371 Date: Nov. 9, 2015

Related U.S. Application Data
(60) Provisional application No. 61/822,024, filed on May 10, 2013.

(51) Int. Cl. H01M 4/70; H01M 4/04

(52) U.S. Cl. CPC H01M 4/70; H01M 4/0411; H01M 4/0471; H01M 2004/021

(57) ABSTRACT

A three-dimensional (3D) electrode architecture for a microbattery includes an anode structure comprising one or more anode digits and a cathode structure comprising one or more cathode digits, the anode digits being positioned alternately with the cathode digits in an interdigitated configuration on a substrate, where each of the anode digits has a width wₐ and each of the cathode digits has a width w_{c}. Each of the anode digits comprises an anode material deposited on a first current collector and extending to a height h above the first current collector, and each of the cathode digits comprises a cathode material deposited on a second current collector and extending to a height h, above the second current collector. A height-to-width aspect ratio hₐ/wₐ of the anode structure and a height-to-width aspect ratio h_{c}/w_{c} of the cathode structure are at least about 2.

### FEDERALLY FUNDED RESEARCH OR DEVELOPMENT

The invention described herein was made with government support under contract number DMI-0749028 awarded by the National Science Foundation and under contract numbers DE-SC0001293 awarded by the Department of Energy. The U.S. Government has certain rights in this invention.

### TECHNICAL FIELD

The present disclosure is related generally to microbattery architectures and more particularly to three-dimensional electrode structures for Li-ion microbatteries.

### BACKGROUND

The proliferation of microscale devices, such as micro-electromechanical systems (MEMS), biomedical sensors, wireless sensors, and actuators drives demand for power sources with commensurate form factors. Three-dimensional (3D) microbattery designs based on micro- and nanostructured architectures could potentially double the energy density by fully utilizing the limited space available. To date, such architectures have been produced in planar and 3D motifs by conventional lithography and colloidal templating methods, respectively.

Direct-write assembly is a facile 3D printing technique that allows functional inks to be precisely printed over areas ranging from tens of square microns to a square millimeter with minimum feature sizes as small as 1 micron. The application of this technology to microbattery fabrication has not been previously explored.

### BRIEF SUMMARY

Described herein is the direct-write assembly of high-aspect ratio anode and cathode structures for Li-ion microbatteries that exhibit exceptionally high areal power and energy densities.

A three-dimensional (3D) electrode architecture for a microbattery includes an anode structure comprising one or more anode digits and a cathode structure comprising one or more cathode digits, the anode digits being positioned alternately with the cathode digits in an interdigitated configuration on a substrate, where each of the anode digits has a width wₐ and each of the cathode digits has a width w_{c}. Each of the anode digits may comprise an anode material deposited on a first current collector and extending to a height hₐ above the first current collector, and each of the cathode digits may comprise a cathode material deposited on a second current collector and extending to a height h_{c} above the second current collector. A height-to-width aspect ratio hₐ/wₐ of the anode structure and a height-to-width aspect ratio h_{c}/w_{c} of the cathode structure are at least about 2.

### BRIEF DESCRIPTION OF THE DRAWINGS

FIG. 1. Schematic illustration of an exemplary 3D interdigitated electrode architecture fabricated on (a) gold current collector patterns by printing (b) Li₄Ti₅O₁₂ (LTO) and (c) LiFePO₄ (LFP) inks through 30 μm nozzles, followed by sintering and (d) packaging. FIGS. 1(e) and 1(f) show different examples of a 3D interdigitated electrode architecture.

FIG. 2. (a) Optical images of LTO and LFP inks. (b) Apparent ink viscosity as a function of shear rate, where LTO is the lower curve, and LFP is the upper curve. (c) Storage modulus as a function of shear stress for each ink, where LTO is the lower curve and LFP is the upper curve. (d) Optical image of LFP ink (60 wt % solids) deposition through a 30 μm nozzle to yield multilayer structure. (e) SEM images, top (left) and side views (right), of the printed and dried multilayer LFP structure. (f) Height and width of printed features as a function of the number of printed layers (30 μm nozzle diameter).

FIG. 3. (a) Optical and (b) SEM images of printed and annealed 16-layer interdigitated LTO-LFP electrode architectures, respectively. Half-cell voltage as a function of areal capacity for (c) LFP and (d) LTO electrodes. (e) Full-cell voltage as a function of areal capacity for an 8-layer electrode structure. (f) Areal capacity of full cell composed of an 8-layer electrode structure measured as a function of number of cycles tested.

FIG. 4. (a) Optical image of 3D interdigitated microbattery architecture (3D-IMA) composed of LTO-LFP electrodes after packaging. (b) Cyclic voltammetry of the packaged 3D-IMA. (c) Charge and discharge curve of the packaged 3D-IMA.

FIG. 5. Comparison of the energy and power densities of our printed, unpackaged 3D interdigitated microbattery architectures (3D-IMA) to reported literature values.

FIG. 6. Thermogravimetric analysis (TGA) of LFP and LTO inks heated at a ramp of 2° C. min⁻¹ in nitrogen.

FIG. 7. SEM images of (a) printed and (b) annealed LTO structures. SEM images of (d) printed and (e) annealed LFP structures. Annealing is carried out at 600° C. for 2 h in argon gas.

FIG. 8. Carbon mapping of annealed (a) LTO and (b) LFP electrode structures. The bright contrast indicates regions with higher carbon distribution. TEM images of annealed (c) LTO and (d) LFP electrode structures.

FIG. 9. Comparison of volumetric energy and power densities of our printed, unpackaged 3D interdigitated microbattery architectures (3D-IMA) to reported literature values.

FIG. 10. Various exemplary packaging schemes are illustrated.

### DETAILED DESCRIPTION

Direct-write assembly, or 3D printing, enables electrochemically active materials to be deposited layer-by-layer on current collector patterns to form high aspect ratio anode and cathode structures that are interdigitated on a sub-millimeter scale. Designed for Li-ion microbatteries, these 3D electrode architectures exhibit amongst the highest areal energy and power densities reported to date.

3D printing entails flowing a precursor ink of a suitable chemistry and viscosity through a deposition nozzle attached to a moving micropositioner with x-, y-, and z-direction capability. A filament comprising the precursor ink is extruded through the nozzle and continuously deposited on a substrate (e.g., on a current collector) in a configuration that depends on the motion of the micropositioner. For example, a single continuous filament of an electrochemically active material may be deposited on a patterned region of a substrate by moving the deposition nozzle along a predetermined path while the precursor ink is supplied to the nozzle. Alternatively, multiple discrete filaments may be formed on the patterned region by starting and stopping the flow of ink during the motion along the predetermined path.

After printing a first layer having the desired pattern, the nozzle may then be raised incrementally in the z (vertical) direction to deposit an additional filament (or multiple additional filaments) on the first layer, thus forming an additional layer of the 3D structure. One or more nozzles operating in series or in parallel may be employed to serially or simultaneously print multiple structures from different precursor inks (e.g., electrode and/or electrolyte precursor inks). The printing process involving motion in the x-, y- and z-directions while precursor ink(s) are controllably flowed through one or more deposition nozzles—may thus be repeated until the desired 3D structure (e.g., an interdigitated microbattery architecture) has been created.

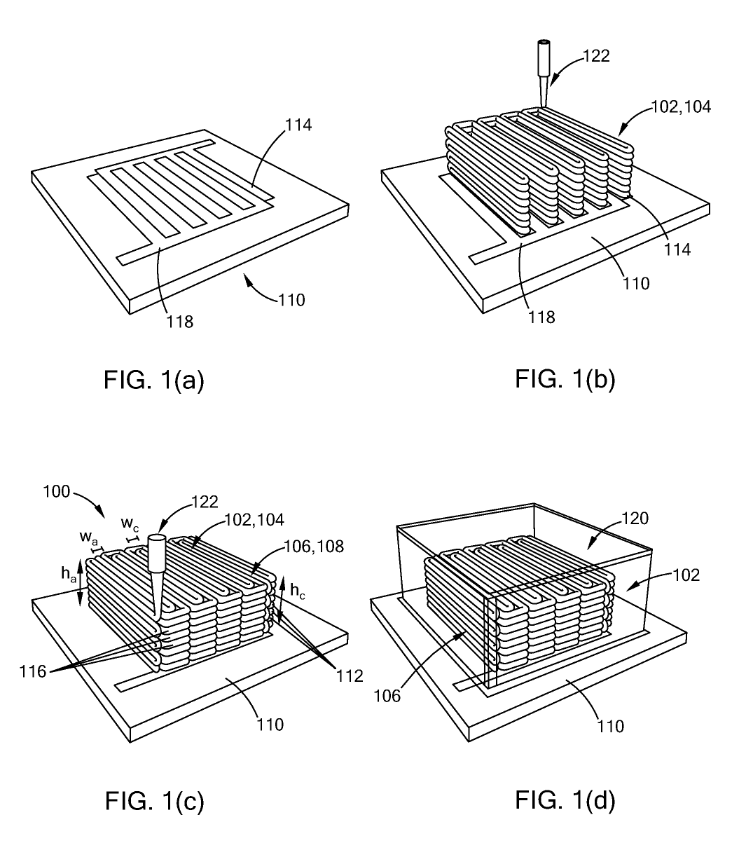

FIGS. 1(a)-1(c) schematically show steps in printing an exemplary 3D electrode architecture for a microbattery. Referring to FIG. 1(a), first and second conductive patterns 114,118 are formed on a substrate 110 in an interdigitated configuration that may be duplicated in the vertical direction with the deposition of anode and cathode materials. The conductive patterns 114,118, which function as current collectors and may have thicknesses of less than about 100 nm, are typically formed using physical or chemical vapor deposition methods followed by conventional lithographic patterning. FIGS. 1(b)-1(c) show the formation of anode and cathode structures 102,106 by depositing or printing filaments comprising the electrode (anode or cathode) materials in a layer-by-layer fashion on each conductive pattern, as described above. An exemplary nozzle 122 used for deposition of the filaments is shown in FIGS. 1(b) and 1(c). After printing, the electrode structures may be heated at a temperature sufficient for sintering of the anode and cathode materials to occur. Alternatively, in embodiments in which the electrode structures are formed from filaments that contain a binder, heating and/or sintering of the electrode structures may not be required. The printed and optionally sintered anode and cathode structures 102,106 may include some amount of porosity (greater than 0 vol. %), which allows for penetration of an electrolyte and facilitates ion transport during charging and discharging. FIG. 1(d) shows a schematic of a packaged microbattery 120 after printing and sintering of the 3D electrode architecture 100.

Referring again to FIG. 1(c), the electrode architecture 100 includes an anode structure 102 comprising one or more anode digits 104 and a cathode structure 106 comprising one or more cathode digits 108 in an interdigitated configuration on the substrate 110. In this example, there are five anode digits 104 positioned alternately with five cathode digits 108.

Each of the anode digits 104 may comprise a plurality of anode layers 112 stacked on a first conductive pattern (or first current collector) 114 to a height hₐ. The anode digits 104 comprise an electrochemically active material that can intercalate lithium ions, such as Li₄Ti₅O₁₂ (LTO), and which is referred to as the anode material. Similarly, each of the cathode digits 108 may comprise a plurality of cathode layers 116 stacked on a second conductive pattern (or second current collector) 118 to a height h_{c}. The cathode digits 108 comprise an electrochemically active material that can intercalate lithium ions, such as LiFePO₄ (LFP), and which is referred to as the cathode material. The anode and/or cathode layers 112,116 may be sintered and/or may include a binder. Thus, individual layers 112,116 of the cathode and/or anode digits 108,104 may be partially or completely coalesced with adjacent layers.

When a microbattery comprising the electrode architecture and a suitable electrolyte is discharged and recharged, lithium ions move from the anode material to the cathode material and back in a reversible process that may be referred to as lithium ion intercalation. The electroactive materials preferably exhibit minimal volumetric expansion to reduce the requirement for compliance in the electrode to accommodate strain that accompanies charge and discharge processes. For example, in the case of an anode structure comprising LTO and a cathode structure comprising LFP, the volumetric expansion may be about 0% and about 2.2%, respectively.

Suitable anode materials may include (where M=metal such as Co, Ni, Fe, Mn, Ti, V, etc.): Li₄Ti₅O₁₂ (LTO), TiO₂, SnO₂, Sn, Si, C, LiM_{y}N₂, and/or M_{y}Oₓ with M in a low oxidation state (e.g., MnO, CoO, Fe₂O₃, Fe₃O₄, CuO, NiO, ZnO), where x and y are integers. Suitable cathode materials may include single or multicomponent oxides, such as (where M=metal such as Co, Ni, Fe, Mn, Ti, V, etc.): LiₓMn_{1-y}M_{y}O₂, Li₁₋ₓMn_{2-y}M_{y}O₄, Li₁₋ₓCo_{1-y}M_{y}O₂, Li₁₋ₓNi_{1-y-z}Co_{y}M_{z}O₄, Li₁₋ₓMPO₄, Li₁₋ₓMSiO₄, Li₁₋ₓMBO₃, LiₓMn_{1-y}M_{y}O₂, and/or V₂O₅, where x, y and z have values from 0 to 1. It should be noted that the terms “anode material” and “cathode material” may be used interchangeably with “electrochemically active material,” “electroactive material” or “electrode material.”

The height of each of the anode and cathode structures is determined by the number of electrode (anode or cathode) layers and the thickness of each layer, which in turn is determined by the 3D printing process employed for fabrication. Each of the electrode digits may include, for example, at least 2 layers, at least 5 layers, at least 8 layers, at least 10 layers, at least 15 layers, or at least 30 layers. Typically, each of the electrode digits includes no more than 100 layers. Assuming a typical layer thickness of about 30 microns, the anode and/or cathode layers may have a height of nearly 1 mm. The exemplary anode and cathode structures 102,106 shown in FIGS. 1(c) and 1(d) are each formed of eight layers to respective heights (hₐ, h_{c}) of about 240 microns, assuming a 30 micron layer thickness.

Each of the anode digits 104 has a width wₐ and each of the cathode digits 108 has a width w_{c} as defined by the underlying conductive pattern 114,118, which provides a two-dimensional pattern or footprint that determines the 2D areal shape of the electrode digits. The first conductive pattern 114 underlies the anode layers 112 and acts as a current collector for the anode structure 102. The second conductive pattern 118 underlies the cathode layers 116 and acts as a current collector for the cathode structure 106. The width wₐ and the width w_{c} may be from about 1 micron to about 200 microns, from about 10 microns to about 100 microns, or from about 20 microns to about 50 microns.

Accordingly, the 3D electrode architecture may have a high aspect ratio and high conductivity. In particular, a height-to-width aspect ratio hₐ/wₐ of the anode structure 102 and a height-to-width aspect ratio h_{c}/w_{c} of the cathode structure 106 may be at least about 2, at least about 3, at least about 5, at least about 10, at least about 20, or at least about 30.

The anode (or cathode) digits may be connected and thus form a continuous anode (or cathode) structure, as shown in FIGS. 1(c) and 1(d); alternatively, the anode (or cathode) digits may be separated such that each of the anode (or cathode) structure comprises an arrangement of discrete digits, as shown for example in FIGS. 1(e) and 1(f). In either case, an interdigitated electrode structure may be formed. In the example of FIG. 1(c), the width of each of the electrode digits is determined by the width of two adjacent filaments of the electroactive material. Alternatively, as shown in FIGS. 1(e) and 1(f), the width of the anode (or cathode) digits may be determined by the width of a single filament of the electroactive material. In other embodiments, the width of the electrode digits may be defined by three or more adjacent filaments of the electroactive material.

Referring again to FIG. 1(c), the filaments comprising the anode material and the filaments comprising the cathode material may have a substantially cylindrical shape as a consequence of being extruded through a nozzle during processing. Accordingly, the one or more filaments may have an average diameter that is the same as or similar to the inner diameter (ID) of the nozzle used for printing. For example, the average diameter of the filament may be within ±20% of the nozzle ID or within about ±10% of the nozzle ID. Because the printed ink may undergo a sintering process after being deposited in layers on the conductive pattern, the transverse cross-sectional shape of the cylindrical filament may include some distortions from a perfect circle while still retaining a substantially circular shape.

Accordingly, the height h_{c} of the cathode layers and the height hₐ of the anode layers may correspond roughly to the diameter of the one or more filaments that make up the respective cathode and anode layers, multiplied by the number of cathode or anode layers. For example, the height h_{c} of the cathode layers and the height hₐ of the anode layers may be from about 10 microns to about 1000 microns.

As noted above, after printing, the electrode structures may be heated to a temperature sufficient to induce sintering of the electroactive materials. For example, a temperature in the range of from about 400° C. to about 800° C. may be suitable for sintering. As discussed further below, the precursor inks comprise particle suspensions that may be optimized in terms of composition and rheology for the printing of each electrode material. The printed filaments therefore have a particulate structure whose structural integrity and relative density may be increased by sintering. In addition, bonding between adjacent electrode layers may be improved by sintering.

Alternatively, layer-to-layer bonding and interlayer structural integrity may be enhanced without sintering by the incorporation of a polymeric binder into the electrode structures. For example, the anode and/or cathode structures may include a polymeric binder in an amount from about 5 vol. % to about 15 vol. %. To achieve this, a small amount of a suitable binder may be added to the precursor inks. In the case of aqueous precursor inks, a binder such as styrene butadiene rubber may be suitable, and for non-aqueous precursor inks, a binder such as polyvinylidene fluoride may be appropriate. Both sintered electrode structures and non-sintered electrode structures (which may or may not include a binder) advantageously contain greater than 0% porosity.

While it is desirable that the anode and cathode materials contain some amount of porosity to allow for penetration of the electrolyte (e.g., about 15 vol. % or greater is believed to be sufficient for open porosity or interconnected pores), it is beneficial in terms of energy density to reduce excess pore space and maximize the active material volume. Consequently, the anode material and the cathode material may each have a porosity of about 15 vol. % or higher, or about 20 vol. % or higher, but typically no more than about 60 vol. %, no more than about 50 vol. %, no more than about 40 vol. %, and no more than about 30 vol. %. For example, the amount of porosity in the cathode material and/or the anode material may be from about 15 vol. % to about 40 vol. %, or from about 15 vol. % to about 30 vol. %.

The conductivity of the electroactive material may be improved by the addition of conductive particles or conductive precursor particles to the precursor ink formulation. Accordingly, the electrode (anode or cathode) material deposited by the 3D printing process may include a plurality of conductive particles distributed therein. The conductive particles may be dispersed in the anode or cathode material at a concentration sufficient for percolation through each electrode layer, so as to provide a conductive pathway to the underlying current collector. The concentration of conductive particles in the precursor ink formulation may be at least about 1 vol. %, at least about 5 vol. %, or at least about 10 vol. %, and no higher than about 50 vol. %.

The conductive particles may comprise any material having an electrical conductivity higher than that of the cathode and/or anode material. For example, the conductive particles may comprise a conductive oxide such as lithium cobalt oxide (LiCoO₂ or LCO), which may be added to a LiMn₂O₄ (LMO) ink formulation. In another example, carbon (C) or metallic particles such as Ag, Cu, Au, Ni, or other transition metals may be added to the precursor ink formulation. Alternatively, conductive precursor particles, such as copper oxide, which may be reduced to metal during sintering of the printed electrode structures, may be added to the precursor ink formulation.

The 3D microbattery architecture may include any number of anode and cathode digits. For example, the anode structure may include from one to 100 anode digits and the cathode structure may include from one to 100 cathode digits. Typically, the number of electrode (anode or cathode) digits is from 3 to 20, or from 5 to 10. Advantageously, the spacing between the anode digits and the cathode digits is minimized and is about 100 microns or less. For example, the spacing between adjacent anode and cathode digits may be about 50 microns or less, about 30 microns or less, or about 10 microns or less. Typically, the spacing is at least about 1 micron, or at least about 5 microns.

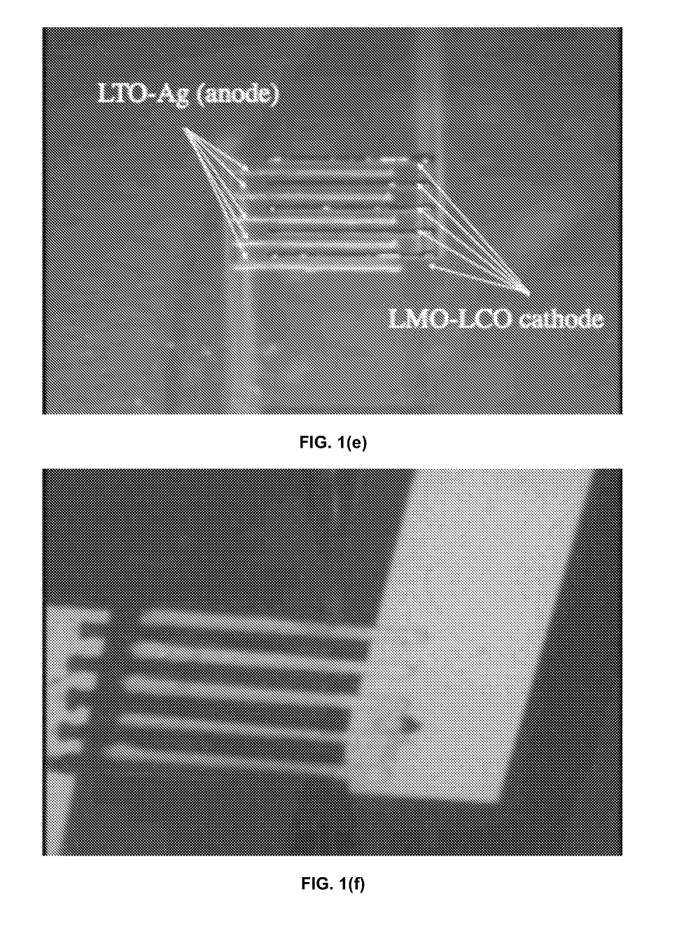

To print high aspect ratio electrode architectures, it is beneficial to optimize the composition and rheology of each ink to ensure reliable flow through fine deposition nozzles, promote adhesion between the printed features, and provide the structural integrity needed to withstand drying and sintering without delamination or distortion. Concentrated anode and cathode inks may be prepared by suspending fine particles of the appropriate active materials in an aqueous solvent via a multi-step process that involves particle dispersion, centrifugation, and homogenization, as described below (see “Experimental Details”). To control ink solidification and adhesion during patterning, a graded volatility solvent system may be used in which the evaporation of water, which has a boiling point (b.p.) of 100° C., induces partial solidification of the printed features ensuring their structural integrity, while humectants such as ethylene glycol (b.p. 197.3° C.) and/or glycerol (b.p. 290° C.) promote bonding between individual layers (FIG. 2(e)). For example, LTO particles having a mean diameter of 50 nm and LFP particles having a mean diameter of 180 nm may be dispersed in a solution comprising deionized water, ethylene glycol, glycerol, and a cellulose-based viscosifier to form an anode precursor ink. To minimize ink clogging during printing, each powder may be centrifuged prior to printing to remove particles above about 300 nm in diameter.

The optimization of concentrated cathode and anode precursor inks is described below, along with the printing and sintering of the inks to form interdigitated electrode structures. The packaging of the electrode structures to form 3D Li-ion microbatteries is also described. Finally, electrochemical characterization results of the electrodes and microbatteries are provided.

In an investigation of anode and cathode precursor inks based on LTO and LFP, respectively, it was found that solids loadings of about 57 wt. % (for LTO) and about 60 wt. % (for LFP) exhibited the desired rheological and printing behavior (FIG. 2(a)). FIG. 2(b) shows the apparent viscosity of the anode and cathode precursor inks as a function of shear rate, where LFP is the top curve and LTO is the bottom curve. Each ink exhibits highly shear thinning behavior with respective apparent viscosities ranging from 10³-10⁴ Pa·s at 1 s⁻¹. FIG. 2(c) shows the storage modulus (G′) of the inks (LFP top; LTO bottom) as a function of shear stress. The plateau modulus of each ink is ˜10⁶ Pa, while the shear yield stress (s,) of the inks ranges from 10²-10³ Pa, respectively.

High aspect ratio, multilayer electrodes were printed onto a glass substrate by depositing the optimized inks through 30 μm cylindrical nozzles (FIG. 2(d)).

Printed features with aspect ratios (h/w, where h is height and w is width) of ˜0.8 are obtained in a single pass with a minimum width of 30 μm and high-aspect ratio features are readily obtained through a layer-by-layer printing sequence (FIG. 2(e)). The SEM images reveal that interfaces of the printed layers are well bonded to one another. FIG. 2(f) shows the height and width of LTO and LFP structures as a function of the number of printed layers. Notably, their height increases linearly with layer number, while their width is nearly constant. The aspect ratios of the patterned microelectrodes range from ˜0.8 to 11 for single to 16-layer high aspect ratio walls.

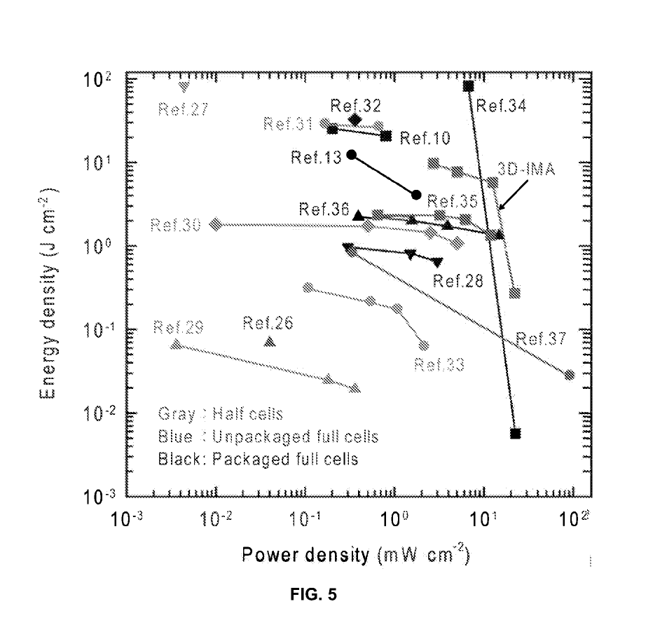

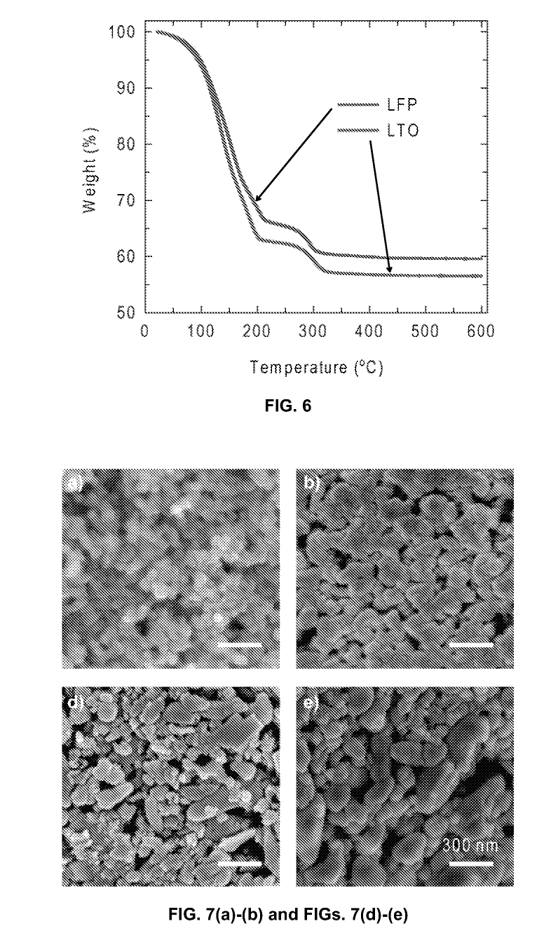

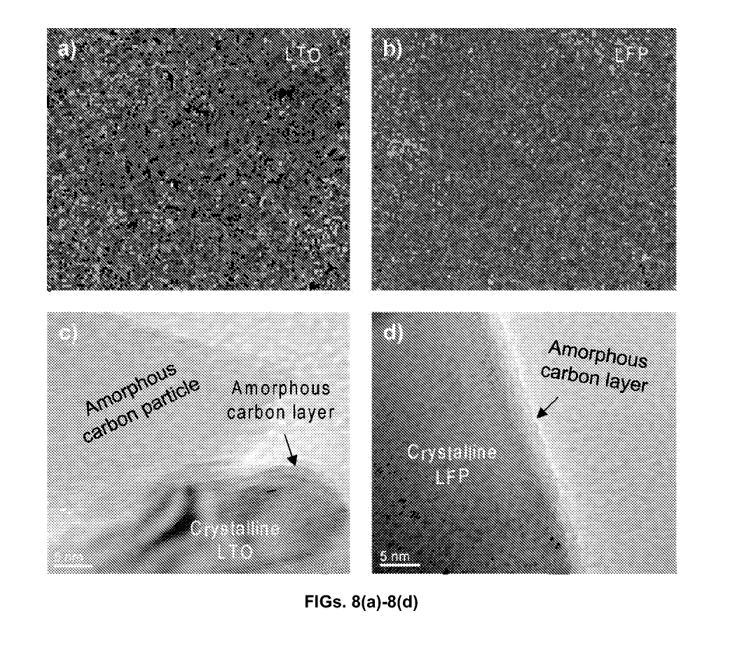

After printing, the dried LTO and LFP microelectrode arrays are heated to 600° C. in inert gas to remove the organic additives and promote particle sintering. Thermal gravimetric analysis (TGA) reveals that the organic species are largely removed by ˜300° C. (FIG. 6). At higher temperatures, the LTO and LFP particles undergo initial stage sintering leading to neck formation at particle-particle contacts. The annealed structures remain highly porous, which is desirable for electrolyte penetration (FIGS. 7(a)-(b) and 7(d)-(e)). The electrical resistivities of the annealed LTO and LFP films measured by four-point probe are 2.1×10⁵ Ω·cm, 2.3×10³ Ω·cm , respectively. These values are significantly lower than their intrinsic electrical resistivities (−10⁹ Ω·cm). It is believed that such differences may arise from residual carbon formed by decomposing the polymeric additives in an inert atmosphere (FIGS. 8(a)-8(d)).

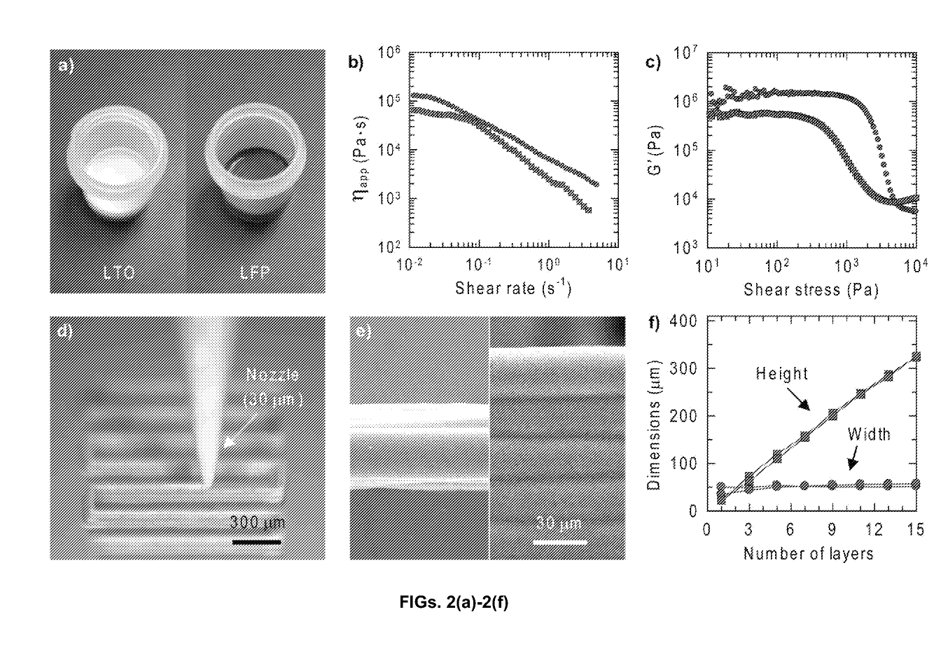

To investigate the electrochemical performance of the electrode architectures, 8-layer and 16-layer 3D-interdigitated microbattery architectures (IMA) (960×800 μm², electrode width=60 μm, spacing=50 μm) were printed on glass substrates (FIG. 3(a)) followed by drying and annealing at 600° C. for 2 h in an inert atmosphere (FIG. 3(b)). The final test structures exhibited minor distortion, but no sign of shorting via contact between adjacent electrodes or delamination from the substrate. Discharge properties were measured for half-cells composed of LFP (FIG. 3(c)) and LTO (FIG. 3(d)) electrodes at varying C rates. The specific capacities for these 8-layer structures at 1 C are calculated to be 160 and 131 mAh g⁻¹, respectively, in good agreement with their respective theoretical values of 170 and 175 mAh g⁻¹. A common feature of both data is the non-monotonic variation in discharge capacity with electrode volume between the 8-layer structures and the 16-layers structures at the lowest rate (1 C). The results indicate that the height of the structure will constrain the kinetics of the reaction. Electronic transport is the only height dependent property in the system, and likely limits the functional height of the 3D-IMA in its current incarnation. At 5 C and 10 C, the 16-layer and 8-layer LFP electrodes exhibit the same current density of 8.33 mAh cm⁻². The complete overlap in these data supports the hypothesis that electronic conduction limits their rate capability, as the total contribution to the capacity results from the same depletion region in both electrodes. Strategies to enhance electronic transport, e.g., through the inclusion of conductive fillers as discussed above, are currently being pursued to enable higher aspect ratio 3D-IMAs.

FIG. 3(e) depicts the areal capacity of an 8-layer LTO-LFP 3D-IMA as a function of C rate. The battery delivers 1.5 mAh cm⁻² at a stable working voltage of 1.8 V when discharged below 5 C. The result corresponds well with the LFP and LTO half-cell results. FIG. 3(f) demonstrates the cycle life of the 3D-IMA. Minimum decay in capacity occurs up to 30 cycles. LFP and LTO both exhibit good cycle life due to their low-strain topotactic reactions that take place at relatively low and high voltages, respectively.

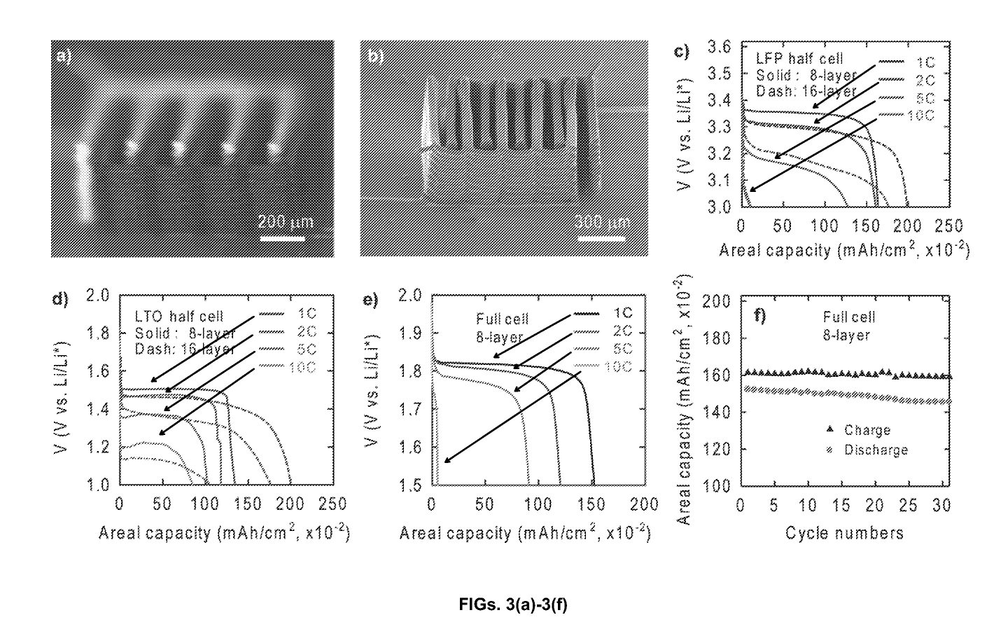

FIG. 4 shows a packaged 3D-IMA. A small plastic case (inner dimensions: 2.1 mm×2.1 mm×1.5 mm) fabricated by laser machining contains the microbattery and liquid electrolyte (FIG. 4(a)). The case dimensions far exceed those needed, and may be reduced by directly printing the liquid (or gel) electrolyte. Cyclic voltammetry performed on the packaged 3D-IMA between 1.0 and 2.5 V at a scan rate of 5 mV s⁻¹ is shown in FIG. 4(b). Stable oxidation and reduction peaks occur at 1.3 V and 2.4 V. After cyclic voltammetry, galvanostatic charge and discharge was conducted at a rate of 0.5 C (FIG. 4(c)). The capacity of the packaged 3D-IMA is 1.2 mAh cm⁻², normalized to the area of the current collector. The packaged battery does not exhibit long-term cyclability due to lack of hermeticity. Effectively packaging microbatteries (<1 mm³) that contain liquid (or gel) electrolyte is quite challenging and few examples of stable packaged microbatteries have been reported to date.

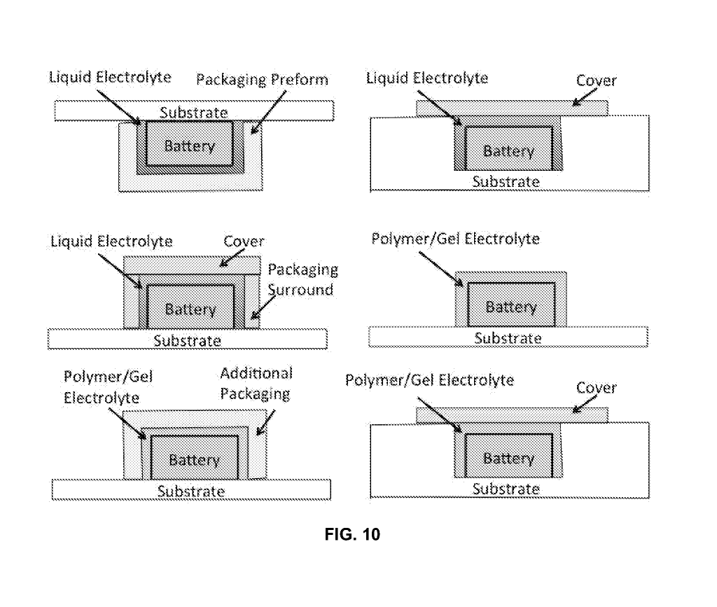

FIG. 10 illustrates several schemes for packaging microbatteries formed by 3D printing on a substrate. The battery contacts the external electrical circuit through thin leads (part of the conductive pattern) that are patterned on the substrate. Batteries may be packaged with liquid, polymer, or gel electrolytes. Non-aqueous electrolytes typically require hermetic sealing to prevent water and oxygen penetration and electrolyte evaporation. Liquid is preferably dispensed in a “cup” geometry. This can be realized practically by patterning the packaging container, patterning the substrate, or a combination of both. The approach utilizing a patterned substrate or a combination approach may require a cover. The cover-packaging interface and packaging-substrate interface may need to be sealed. Thermoset and thermoplastic polymers that do not react with the electrolyte could function as an adhesive sealant. Such polymers include silicone, certain epoxies, polyethylene, or polypropylene. The packaging preform could be composed of similar polymers (e.g., PE, PP, epoxy, Teflon) or electrically insulating ceramics (e.g., Al₂O₃, MgO). Non-aqueous electrolytes are typically based on aprotic solvents such as ethylene carbonate, dimethyl carbonate, propylene carbonate, or diethyl carbonate mixed with a Li containing salt such as LiPF₆ or LiOCl₄. Polymer and gel electrolytes typically add a polymer host and a cross-linking agent to a non-aqueous electrolyte system. Exemplary polymer hosts include polyethylene oxide, polypropylene oxide, poly acrylonitrilde, polymethyl methacrylate, or polyvinylidene fluoride. Appropriate cross-linking agents for each are known in the art. Thermally activated or UV activated crosslinkers are ideal in order to allow the electrolyte to flow into the porosity of the microbattery prior to cross-linking. In an ideal implementation of the technology, the volumetric shrinkage associated with cross-linking is minimized to minimize stress on the structure. It is recognized that increasing the modulus of the polymer or gel electrolyte decreases the ionic conductivity.

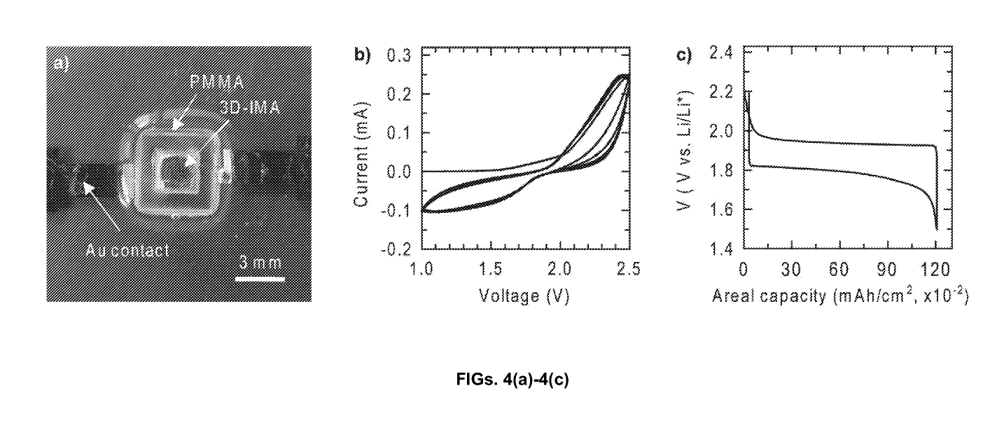

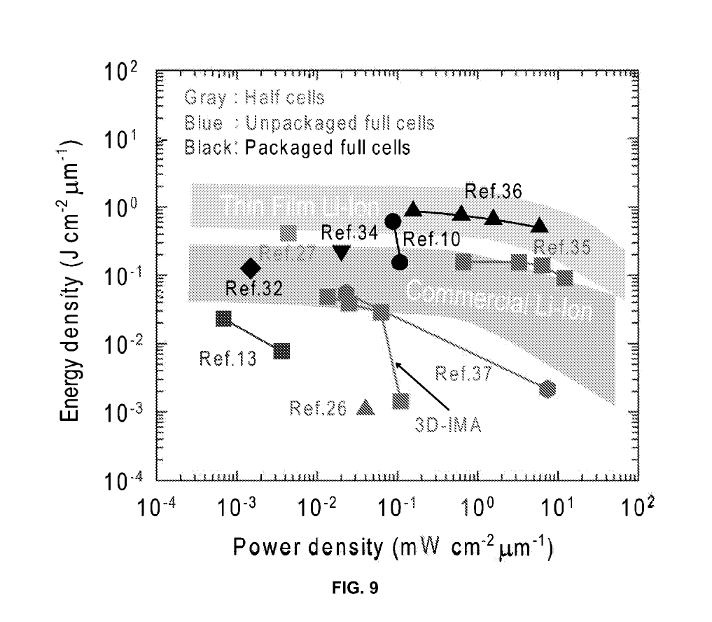

The Ragone plot in FIG. 5 compares the areal energy and power densities of the 3D-IMA described here with other relevant data recently reported in the literature. A complementary Ragone plot that compares their performance in terms of volumetric energy and power density is provided in FIG. 9. Data for the fully packaged 3D-IMA is not included in either plot due to the excessively large, non-optimized package dimensions. The printed 3D-IMA compares favorably against its rechargeable counterparts in terms of both areal energy and power density. The excellent performance results from the fabrication of high-aspect structures that occupy a small areal footprint, while maintaining reasonably small transport length scales to facilitate facile ion and electron transport during charging and discharging processes. While the low voltage electrochemical couple demonstrated here limits the volumetric energy density, the present approach can readily be extended to other commercial lithium ion chemistries, such as LiCoO₂/graphite, to yield volumetric energy densities competitive with those reported elsewhere.

### Experimental Details

LTO and LFP Inks: LTO powder (mean diameter=50 nm, specific surface area=32.6 m² g⁻¹, density=3.539 g cm⁻³) was purchased from Sigma Aldrich. LFP powder (particle size<300 nm, density=2.947 g cm⁻³) is synthesized by a solid-state reaction, as described in detail elsewhere. Highly concentrated LTO (57 wt % solids) and LFP (60 wt % solids) inks are prepared by first dispersing 4.5 g of LTO nanoparticles in 110 ml of deionized (DI) water and 40 ml of ethylene glycol (EG, Fisher Scientific) and 3.0 g of LFP nanoparticles in 80 ml of DI water and 40 ml of EG. These suspensions are ball milled for 24 h at room temperature and then classified by a two-step centrifugation process. The suspensions are first centrifuged at 4000 rpm for 5 min to eliminate large agglomerates, followed by centrifugation at 3500 rpm for 2 h to collect fine particles (mean diameter of 180 nm). The collected nanoparticles are re-dispersed with appropriate addition of glycerol (Fisher Scientific), 3.5 wt % aqueous hydroxypropyl cellulose (HPC, Sigma Aldrich, Mw˜100,000) solution, and 3 wt % aqueous hydroxyethyl cellulose (HEC, Sigma Aldrich) solution. The resultant homogenized LTO mixture is composed of (relative to their solids content) 27 wt % Glycerol, 20-30 wt % EG, 9 wt % HPC, 1 wt % HEC, and DI water; whereas the LFP contained 20 wt % glycerol, 8 wt % HPC, 2 wt % HEC, and DI water. Through solvent evaporation at room temperature, their final solids loading (nanoparticles and cellulose) is optimized to be 55-65 wt %. Ink rheology is measured in both shear viscometry and oscillatory modes using a controlled-stress rheometer (C-VOR, Malvern Instruments, Malvern, UK) equipped with C14 cup and bob at 25° C. in the presence of a solvent trap to prevent evaporation. The apparent viscosity (n) is acquired as a function of shear rate (0.01-500 s⁻¹) in a logarithmically ascending series. The shear storage (G′) and viscous loss (G″) moduli are measured in an oscillatory mode as a function of controlled shear stress (10-10,000 Pa) at a frequency of 1 Hz with increasing amplitude sweep.

3D printing: Before printing, interdigitated gold current collector patterns (960×800 μm², digit width=70 μm, digit spacing=50 μm) are patterned on glass substrates by a combination of lithographic patterning and e-beam deposition. The inks are printed using a 3-axis micropositioning stage (ABL 900010, Aerotech Inc., Pittsburgh, Pa.), whose motion is controlled by computer-aided design software (RoboCAD, 3D Inks, Stillwater, Okla.). The LFP and LTO inks are housed in separate syringes (3 mL barrel, EFD Inc., East Providence, R.I.), which are attached by luer-lok to a borosilicate micronozzle (30 μm in diameter produced using a P-2000 micropipette puller, Sutter Instrument Co., Novato, Calif.). An air-powered fluid dispenser (800 ultra dispensing system, EFD Inc.) is used to pressurize the barrel and control the ink flow rate. The typical printing speed for both LTO and LFP inks by a 30-μm nozzle is ˜250 μm s⁻¹ at 600 psi. After printing, the structures are annealed at 600° C. for 2 h in argon gas using a tube furnace. Their microstructures are characterized using SEM (Hitach S-4700). The calculated active mass of the printed LFP and LTO electrodes are 15 and 16 μg per layer, respectively, based on their filament geometry and the measured solids loading of each ink.

Microbattery packaging: A thin-walled poly(methyl methacrylate) (PMMA) preform is laser cut and placed around the microbattery and sealed with PDMS gel (Sylgard 184, Dow Corning, Inc.), cured at 150° C. The assembly is filled with electrolyte and sealed with small glass cover using additional PDMS.

Electrochemical characterization: All measurements are carried out in an argon-filled glovebox (Mbraun labstar), and electrochemical data is collected with a commercial potentiostat (SP200, Biologic Co.). For the half-cell test, the LFP and LTO electrodes are immersed in nonaqueous electrolyte (1 M LiClO₄ in 1:1 ratio of ethylene carbonate:dimethyl carbonate by volume). A piece of lithium metal served as both the counter and reference electrodes. Cyclic voltammetry and galvanic charge/discharge are performed to check the electrochemical reactivity and rate capability. For the rate test, the charge rate is maintained at C/2, and discharge rates are varied from 1 C to 10 C. The cycling life is also measured in constant current, and both the charge and discharge rates are fixed at 1 C. For the full cell tests in liquid electrolyte, the same tests are performed again, where LFP and LTO serve as the cathode and anode, respectively.

In summary, printed novel 3D microbatteries composed of high-aspect ratio electrodes in interdigited architectures have been fabricated. Careful design of concentrated LFP and LTO viscoelastic inks enabled printing of these thin-walled anode and cathode structures. Using an exemplary LFP-LTO chemistry, a 3D-IMA has been demonstrated with a high areal energy density of 9.7 J cm⁻² at a power density of 2.7 mW cm⁻². Such devices may find potential application in autonomously powered microelectronics and medical micro-implants.

Although the present invention has been described in considerable detail with reference to certain embodiments thereof, other embodiments are possible without departing from the present invention. The spirit and scope of the appended claims should not be limited, therefore, to the description of the preferred embodiments contained herein. All embodiments that come within the meaning of the claims, either literally or by equivalence, are intended to be embraced therein.

Furthermore, the advantages described above are not necessarily the only advantages of the invention, and it is not necessarily expected that all of the described advantages will be achieved with every embodiment of the invention.

1. A three-dimensional (3D) electrode architecture for a microbattery, the electrode architecture comprising:
an anode structure comprising one or more anode digits and a cathode structure comprising one or more cathode digits, the anode digits being positioned alternately with the cathode digits in an interdigitated configuration on a substrate, each of the anode digits having a width wₐ and each of the cathode digits having a width w_{c},
wherein each of the anode digits comprises an anode material deposited on a first current collector, the anode material extending to a height hₐ above the first current collector, and
wherein each of the cathode digits comprises a cathode material deposited on a second current collector, the cathode material extending to a height h_{c} above the second current collector, and
wherein a height-to-width aspect ratio hₐ/wₐ of the anode structure and a height-to-width aspect ratio h_{c}/w_{c} of the cathode structure are at least about 2.

2. The 3D electrode architecture of claim 1, wherein the height-to-width aspect ratio hₐ/wₐ and the height-to-width aspect ratio h_{c}/w_{c} are at least about 10.

3. The 3D electrode architecture of claim 1, wherein each of the anode digits comprises a plurality of anode layers stacked on the first current collector, the plurality of anode layers comprising the anode material and being stacked to the height hₐ, and
wherein each of the cathode digits comprises a plurality of cathode layers stacked on the first current collector, the plurality of cathode layers comprising the cathode material and being stacked to the height h_{c}.

4-5. (canceled)

6. The 3D electrode architecture of claim 1, wherein the height h_{c} and the height hₐ are from about 100 microns to about 1 mm.

7. The 3D electrode architecture of claim 1, wherein the width wₐ and the width w_{c} are from about 10 microns to about 100 microns.

8. The 3D electrode architecture of claim 1, wherein each of the anode material and the cathode material comprises a porosity of from about 15 vol. % to about 40 vol. %

9. (canceled)

10. The 3D electrode architecture of claim 1, wherein the anode material is selected from the group consisting of: Li₄Ti₅O₁₂, TiO₂, SnO₂, Sn, Si, C, LiM_{y}N₂, MnO, CoO, Fe₂O₃, Fe₃O₄, CuO, NiO, ZnO, where y is an integer.

11. The 3D electrode architecture of claim 1, wherein the cathode material is selected from the group consisting of: LiₓMn_{1-y}M_{y}O₂, Li₁₋ₓMn_{2-y}M_{y}O₄, Li₁₋ₓCo_{1-y}M_{y}O₂, Li₁₋ₓNi_{1-y-z}Co_{y}M_{z}O₄, Li₁₋ₓMPO₄, Li₁₋ₓMSiO₄, Li₁₋ₓMBO₃, LiₓMn_{1-y}M_{y}O₂, and V₂O₅, where M is a transition metal and x, y and z have values from 0 to 1.

12. The 3D electrode architecture of claim 1, wherein at least one of the anode material and the cathode material further comprise a plurality of conductive particles distributed therein.

13. The 3D electrode architecture of claim 12, wherein the conductive particles comprise an element selected from the group consisting of: C, Ag, Cu, Au, Ni, and other transition metals.

14. The 3D electrode architecture of claim 1, comprising at least five anode digits and at least five cathode digits.

15. The 3D electrode architecture of claim 1, wherein the anode digits comprise a spacing from the cathode digits of about 50 microns or less.

16-17. (canceled)

18. A method of making a 3D electrode architecture, the method comprising:
providing a first nozzle positioned above a substrate having a first conductive pattern deposited thereon;
while moving the first nozzle along a first predetermined pathway, extruding a first electrode filament comprising a first electrochemically active material out of the first nozzle and depositing the first electrode filament on the first conductive pattern, the first electrode filament being deposited in a digitated configuration; and
repeating the extrusion and deposition of the first electrode filament at increasing distances above the substrate to form a first multilayered electrode structure comprising one or more first electrode digits.

19. The method of claim 18, further comprising, while moving a second nozzle along a second predetermined pathway, extruding a second electrode filament comprising a second electrochemically active material out of the second nozzle and depositing the second electrode filament on a second conductive pattern on the substrate, the second electrode filament being deposited in a digitated configuration; and
repeating the extrusion and deposition of the second electrode filament at increasing distances above the substrate to form a second multilayered electrode structure comprising one or more second electrode digits,
wherein the one or more first electrode digits are interdigitated with the one or more second electrode digits, and wherein a height-to-width aspect ratio of each of the first and second multilayered electrode structures is at least about 2.

20. The method of claim 19, further comprising heating the first and second multilayered electrode structures at a temperature sufficient to induce sintering of the first and second electrochemically active materials.

21. The method of claim 19, wherein each of the first and second electrode filaments further comprise a polymeric binder.

22. The method of claim 19, wherein the first nozzle and the second nozzle are moved in series, the deposition of the first electrode filament and the deposition of the second electrode filament occurring serially.

23. The method of claim 19, wherein the first nozzle and the second nozzle are moved in parallel, the deposition of the first electrode filament and the deposition of the second electrode filament occurring simultaneously.

24. The method of claim 18, wherein the first electrochemically active material is selected from the group consisting of Li₄Ti₅O₁₂, TiO₂, SnO₂, Sn, Si, C, LiM_{y}N₂, MnO, CoO, Fe₂O₃, Fe₃O₄, CuO, NiO, ZnO, where y is an integer.

25. The method of claim 18, wherein the second electrochemically active material is selected from the group consisting of: LiₓMn_{1-y}M_{y}O₂, Li₁₋ₓMn_{2-y}M_{y}O₄, Li₁₋ₓCo_{1-y}M_{y}O₂, Li₁₋ₓNi_{1-y-z}Co_{y}M_{z}O₄, Li₁₋ₓMPO₄, Li₁₋ₓMBO₃, LiₓMn_{1-y}M_{y}O₂, and V₂O₅, where M is a transition metal and x, y and z have values from 0 to 1.
